(19) United States
(12) Patent Application Publication
(10) Pub. No.: US 2019/0012497 A1
(43) Pub. Date: Jan. 10, 2019

(54) MONITORING AND ENVIRONMENTAL CONTROL SYSTEM FOR ANIMAL HOUSING

(71) Applicant: Sixth Labor LLC, St. Paul, MN (US)

(72) Inventors: Andrew Ralston, St. Paul, MN (US); Minh Anderson, Brooklyn Park, MN (US)

(73) Assignee: Sixth Labor LLC, St. Paul, MN (US)

(21) Appl. No.: 16/031,729

(22) Filed: Jul. 10, 2018

Related U.S. Application Data
(60) Provisional application No. 62/530,592, filed on Jul. 10, 2017.

(51) Int. Cl. G06K 7/10; A01K 11/00; A01K 31/16

(52) U.S. Cl. CPC G06K 7/10099; A01K 31/165; A01K 11/006

(57) ABSTRACT

A monitoring and environmental control system for animal housing is provided. The system includes at least one sensor to monitor animal behavior, at least one database to store sensor data from the at least one sensor, at least one environmental control to control at least one environmental system associated with the animal housing, at least one memory to store operating instructions and at least one system controller. The at least one system controller is configured to implement the operation instruction to activate the at least one environmental control to adjust the at least one environmental system based at least in part on sensor data from the at least one sensor. The monitoring and environmental control system for animal housing further includes at least one user interface in communication the at least one system controller.

### CROSS-REFERENCE TO RELATED APPLICATIONS

This application claims priority to U.S. Provisional Application Ser. No. 62/530,592, same title herewith, filed on Jul. 10, 2017, which is incorporated in its entirety herein by reference.

### BACKGROUND

Environmental conditions within a housing for animals, such as livestock, directly affects the health and wellbeing of the animals. Moreover, desired behavior in animals may be achieved by selectively controlling environmental conditions within the housing. Identifying environmental conditions that positively affects the animals can be challenging in that it may take a lot of time observing behaviors while changing the conditions. Further different animals from the same species may react differently to the same environmental conditions. In addition other factors beyond environmental conditions may also affect the health and wellbeing of animals. To be able to determine these other factors may again take a lot of observation and trial and error in trying to achieve a desired behavior in the animals.

### SUMMARY

The following summary is made by way of example and not by way of limitation. It is merely provided to aid the reader in understanding some of the aspects of the subject matter described. Embodiments provide a monitoring and environmental control system for animal housing. In embodiments, animal behavior is monitored with sensors and environmental conditions may be automatically adjusted as a result of sensor data received from the sensors.

In one embodiment, a monitoring and environmental control system for animal housing is provided. The system includes at least one sensor to monitor animal behavior, at least one database to store sensor data from the at least one sensor, at least one environmental control to control at least one environmental system associated with the animal housing, at least one memory to store operating instructions and at least one system controller. The at least one system controller is in communication with the at least one memory. The at least one system controller is also in communication to receive sensor data from the at least one sensor. Moreover, the at least one system controller is further in communication with the at least one database. The at least one system controller is configured to implement the operation instruction to activate the at least one environmental control to adjust the at least one environmental system based at least in part on sensor data from the at least one sensor. The monitoring and environmental control system for animal housing further includes at least one user interface in communication the at least one system controller.

In another embodiment, a method of operating an animal monitoring and control system is provided. The method includes monitoring animal behavior with at least one sensor and adjusting at least one environmental system based at least in part on a select monitored animal behavior captured by the at least one sensor.

In still another embodiment, a method of operating a chicken monitoring and control system is provided. The method includes: attaching an identifying tag on each chicken to be monitored; tracking the location of each chicken via the attached identifying tag; collecting location data of each chicken over a period of time; and processing the collected location data over a period of time to determine at least one of trends, anomalies and factors.

### BRIEF DESCRIPTION OF THE DRAWINGS

Embodiments can be more easily understood and further advantages and uses thereof will be more readily apparent, when considered in view of the detailed description and the following figures in which:

FIG. 1 is a block diagram of a monitoring and environmental control system for animal housing system according to one exemplary embodiment;

FIG. 2 is a block diagram of a monitoring and environmental control system for animal housing system according to one exemplary embodiment;

FIG. 3 is a monitoring and environmental control system flow diagram according to one exemplary embodiment; and

FIG. 4 is a chicken monitoring and environmental control system flow diagram according to one exemplary embodiment.

In accordance with common practice, the various described features are not drawn to scale but are drawn to emphasize specific features relevant to the subject matter described. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the embodiments, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments provide a monitoring and environmental control system for animal housing. The monitoring may be used to determine key actives under taken by each animal. In an embodiment, aggregate activity information across disparate groups of animals may be used to determine trends, anomalies and factors that influence behavior in positive or negative ways across a broader context than has previously been possible for an organization. Some embodiments allow influence of the environment impact the behavior of the animals. Further some embodiments predict future behavior based on historical data gathered on each animal and/or data gathered on similar animals and environments.

In embodiments, a variety of sensors, smart-sensors and control systems that may be combined together to create an ad-hoc network to collect data about the animals and the environment are used. Moreover, embodiments anticipate future sensors that have not yet been created to be connected to the system. Some embodiments enable a bidirectional communications approach to allow smart-sensors and control-systems to gather and respond to data. The mixing and matching of different smart-sensors and/or control systems enables embodiments to be highly responsive to the needs of the end users. Although, embodiments describe below provide example applications relating to chickens, embodiments may be applied to any type of a livestock or to other situations where animals need to be monitored.

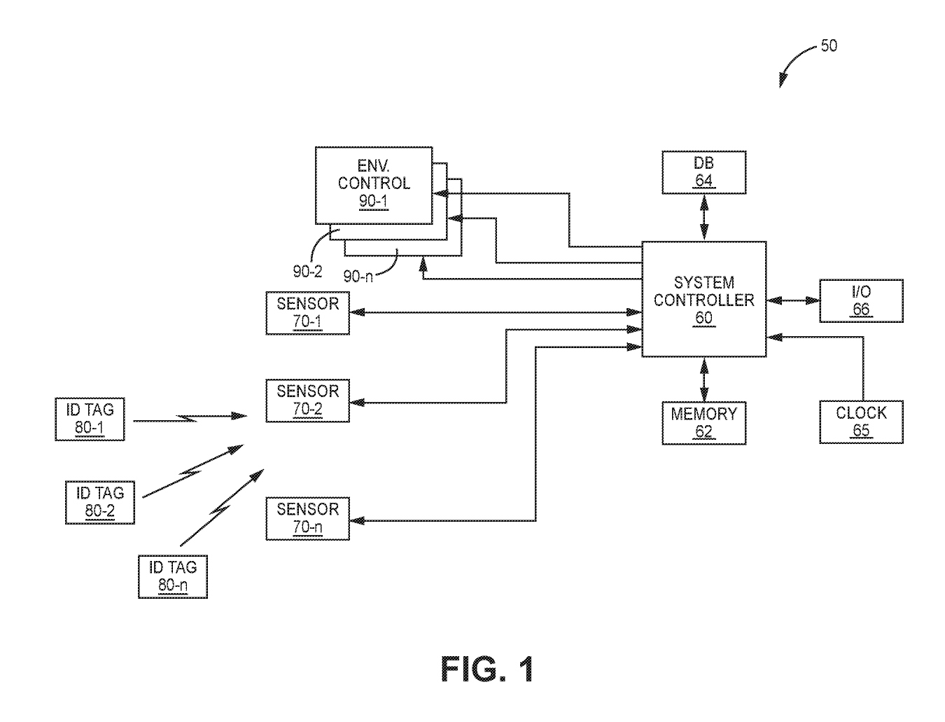

FIG. 1 illustrates a block diagram of an exemplary monitoring and environmental control system 50 that may be employed. As discussed above, embodiments provides a system of monitoring and environmental control for an animal housing system. The example embodiment system 50 of FIG. 1 is shown as including a plurality of sensors 70-1 through 70-n. The sensors 70-1 through 70-n are positioned to sense various aspects related to the livestock. For example, sensors 70-1 through 70-n may include environmental sensors such as, but not limit to, temperature sensors, humidity sensors, pressure sensors, light level sensors, etc. or behavior sensors, such as but not limited to, image sensors, audio sensors, infrared sensors, etc. The sensors may be generally indicated as 70.

Another example of a behavior sensor 70 is an identification reader such as, but not limited to, a radio frequency identification (RFID) reader. Sensor 70-2 of FIG. 1 is illustrated as being an identification reader that reads identification (ID) tags 80-1 through 80-n. The ID tags (generally indicated as 80) are attached to select animals to be monitored. In the RFID reader 70-2 example, the ID tags 80 are RFID tags 80. Other types of identification tags and sensors are contemplated.

At least one system controller 60 is in communication with the sensors 70 to receive sensor data form the respective sensors 70. The at least one system controller 60 stores the sensor data in a database 64 and uses the stored sensor data to determine trends, anomalies and factors that influence animal behavior. The system controller 60 is also in communication with at least one memory 62 that stores operating instructions that are implemented by the at least one system controller 60. Also illustrated in the embodiment of FIG. 1, is a user input/output (I/O) 66 that is in communication with the system controller 60. The I/O 66 may be a display, keyboard, audio interface, and the like, that provides an interface between the user and the system controller 60. Also illustrated is a clock 65 in which the system controller 60 is in communication with. The clock 65 may be used for tracking time associated with sensor data.

Further, the exemplary monitoring and environmental control system 50 of FIG. 1 includes at least one environmental control 90-1 through 90-n that is in communication with the system controller 60. Examples of environmental controls 90-1 through 90-n includes, but are not limited to, temperature controls, light controls, humidity control, air flow controls, door controls, etc. An environmental control may be generally identified by 90. In one embodiment, the at least one system controller 60 is configured to control select environmental control 90 based at least in part on sensor data from the sensors 70.

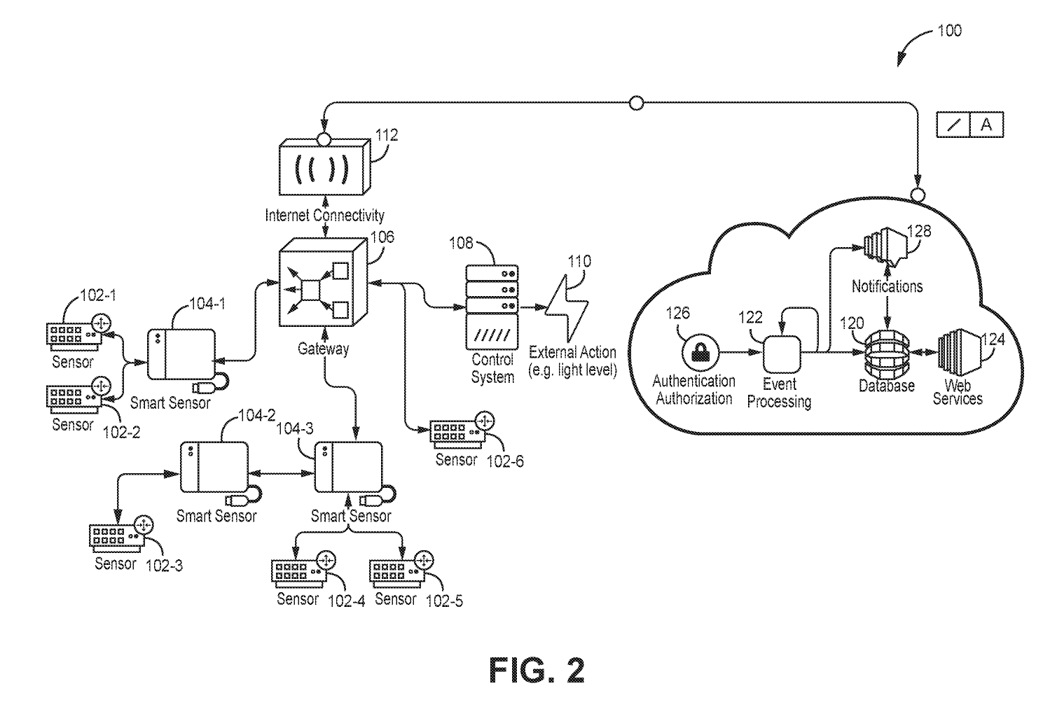

FIG. 2 illustrates another example embodiment a monitoring and environmental control system 100 for animal housing. This embodiment also includes a plurality of sensors 102-1 through 102-6. The sensors 102-1 through 102-6 are position to sense various aspects related to the livestock. For example, the sensors 102-1 through 102-6 may include environmental sensors such as, but not limit to, temperature sensors, humidity sensors, pressure sensors, light level sensors, etc. or behavior sensors, such as but not limited to, image sensors, audio sensors, infrared sensors, location sensors, etc. The sensors may be generally indicated as 102.

One or more of the sensors 102 may be in communication with a smart sensor 104-1 through 104-3. For example, the example embodiment of FIG. 2 illustrates sensors 102-1 and 102-2 are in communication with smart sensor 104-1, sensor 102-3 is in communication with smart sensor 104-2 and sensors 102-4 and 102-5 are in communication with smart sensor 104-3. The smart sensors can generally be designated as 104. The smart sensors 104 are described further below as a combination of one or more sensors and computing/software that is designed to gather specific types of data. The sensors 102 are in communication with a gateway 106 either directly or via a smart sensor 104. Also in communication with the gateway 106 is a control system 108 that is configured to provide control of aspects affecting conditions the animals are experiencing such as lighting, temperature, humidity, air flow, door position and the like which are generally indicated via 110. The gateway 106 provides an interface to a communication platform, such as but not limited to, the World Wide Web via the internet 112.

At the other end of the system 100 is a database 120 used to store sensor information and an event processing system 122 (system controller) that is in communication with the internet, in this example. The system controller 122 in an embodiment includes at least one processor and at least one memory to store operating instructions implemented by the at least one processor. The at least one processor is in communication with the gateway 106 via the communication platform. In the example system 100 in FIG. 1, an authentication authorization is used in a user input/output 126 to allow access to the processor of the event processing system 122. Based on data collected, notifications may generated, stored in the database 120 and provided to remote users 128. As further illustrated, the database 120 has access to web services 124.

In general, the at least one system controllers 122 and 60 described above, may include any one or more of a processor, microprocessor, a digital signal processor (DSP), an application specific integrated circuit (ASIC), a field program gate array (FPGA), or equivalent discrete or integrated logic circuitry. In some example embodiments, the at least one system controller may include multiple components, such as any combination of one or more microprocessors, one or more controllers, one or more DSPs, one or more ASICs, one or more FPGAs, as well as other discrete or integrated logic circuitry. The functions attributed to the at least one processor herein may be embodied as software, firmware, hardware or any combination thereof. The at least one system controller 122 and 60 may be part of a system or a component controller. In embodiments, the at least one system controller may employ various memory such as memory 62 described above. A memory may include computer-readable operating instructions that, when executed by the system controller 122 and 60 provide functions of the monitoring and environmental control system. Such functions may further include functions described below. The computer readable instructions may be encoded within the memory. The memory may comprise computer readable storage media including any volatile, nonvolatile, magnetic, optical, or electrical media, such as, but not limited to, a random access memory (RAM), read-only memory (ROM), non-volatile RAM (NVRAM), electrically-erasable programmable ROM (EEPROM), flash memory, or any other storage medium. Although not shown, embodiments, may also have at least one user input to provide instructions, authentication authorization, information, etc. into the system.

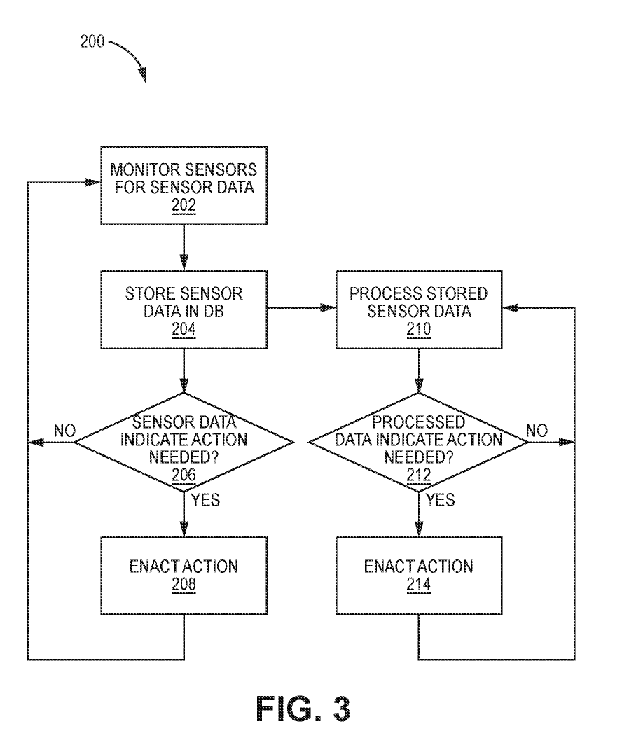

Referring to FIG. 3, a monitoring and environmental control system flow diagram 200 of an example embodiment is illustrated. Flow diagram 200 is provided in a series of sequential steps. However, the sequential order of the steps may be different in other embodiments. In the Example of FIG. 3, the process starts by monitoring the sensors 70 or 102 for sensor data at step (202). Monitored sensor data is stored in a database 64 or 120 at step (204). It is then determined if the sensor data indicates that an action needs to be taken at step (206). If it is determined that an action need not be taken at step (206), the process continues by monitoring the sensors 70 or 102 for sensor data at step (202). If it is determined that an action needs be taken at step (206), an action is enacted at step (202). Examples of possible actions include adjusting environmental controls or generating an alarm or message to a user.

Also illustrated in flow diagram 200 of the FIG. 3 is that the stored sensor data in the database 64 or 120 is selectively processed at step (210). The processing may provide for example aggregate activity information across disparate groups of animals to determine trends, anomalies and factors that influence behavior in positive or negative ways. It is determined at step (212) whether the processed data indicates that an action is needed. If the processed data indicates that an action is not needed at step 212, the process continues by processing further stored data at step (210). If the processed data indicates that an action is needed at step 212, a corresponding action is taken at step (210). Examples of possible actions include adjusting environmental controls, generating an alarm or message to a user. Hence, the flow diagram 200 example, sensed data may indicate an action is needed right away or the accumulation and processed sensor data may indicate an action needs to be taken.

Examples of information generated and produced from gathered sensor information by sensors 102 and 70 described above, in a chicken monitoring embodiment, include which bird laid an egg and when, bird laying trends over time, cold temperature warnings, high humidity warnings, temperature/humidity/light graphs/entry/exit graphs, supplemental light management, heat management, web based dashboard to see data, SMS notification of key chicken activities, a count of chickens in coop, etc.

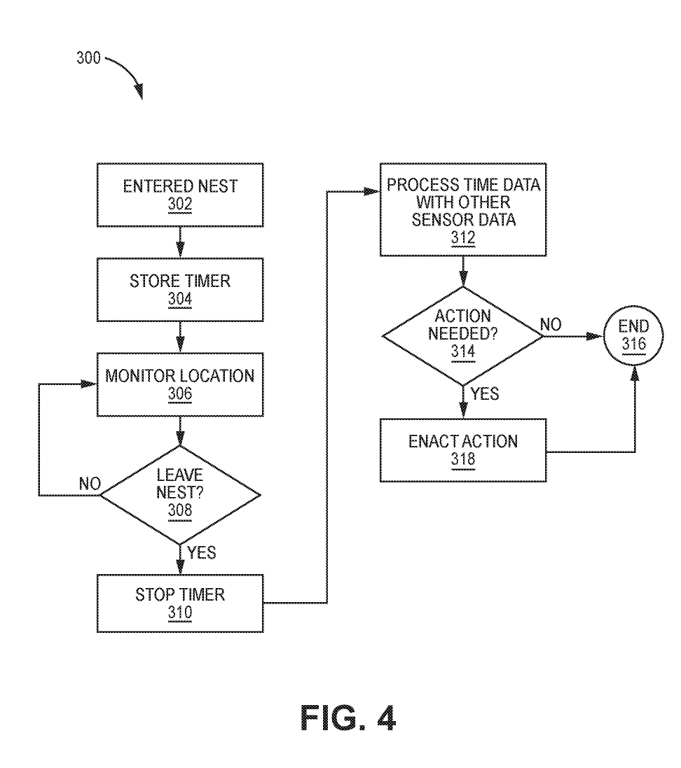

An example of a chicken monitoring and environmental control system flow diagram 300 that may be implemented by the monitoring and environmental control systems 50 and 100 described above is illustrated in FIG. 4. As with flow diagram 200 described above, flow diagram 300 is also provided as sequential steps. The sequence of steps may be different in other embodiments. Hence, embodiments are not limited in a particular sequence. In this example flow diagram 300, the chickens are monitored. When a chicken has entered a nest, the process starts at step (302). A timer is stated at step (304). In one embodiment, the system controller 60 provides the timer functions with use of the clock 65.

The location of the chicken is monitored at step (306). Based on the monitoring it is determined if the chicken has left the nest at step (308). If it is determined that the chicken is still in the nest at step (308), the monitoring continues at step (306). If it is determined that the chicken has left the nest at step (308) the timer is stopped at step (310). Determined time data is processed with other sensor data at step (312). It is then determined, in this example, if action is needed based on the processed of data at step (314). If it is determined that no action is needed at step (314) the process ends at step (316). If is determined at step (314) that action is needed, corresponding action is taken at step (318). The process then ends at step (316). The action may include, but is not limited to changing an environmental condition, generating an alarm and generating a message that further action should be taken.

By gathering data about the behavior of the animal and combining it with environmental information various issues associated with the animal can be identified and addressed. For example, if a female chicken is sitting on their nest for approximately 45 minutes the bird is likely laying an egg. If the bird is on the nest for greater than approximately 90 minutes, the bird may be broody. If either of these conditions take place during periods of low light, the bird may be not allowed on the roost which indicates a low position in the bird's hierarchy. The observed behaviors are gathered across flocks along with additional data such as breed, age, gender, location, temperature, weather data etc. The combination of this data allows further intelligence to be gathered and derived about the specific circumstances which will be optimal for each animal/group of animals.

Systems 50 and 100 described above are able to define the hierarchy of the birds within the flock. Embodiments may use the order of nesting along with audio inputs to determine social hierarchy by identifying when a more dominant chicken forces another bird to move off of the nest. The presence of poultry audio along with an abrupt transition between birds in the nesting box indicates that the second bird is more dominant than the first. Another factor that helps determine hierarchy within the flock is the order in which they lay with the more dominant birds laying earlier in the day and laying more often.

As described above, in one embodiment an RFID tag 80 is attached to an animal to be monitored, such as a chicken. An RFID reader and one or more antennas (that make up the sensor 70-2) are placed in the space where the chicken nests/lays eggs to track animal events. The antennas are turned on at a regular interval to check for the presence of the RFID tags 80 in the nesting area. The presence of a RFID tag 80 in the nesting box for a period of greater than 30 minutes and less than four hours during daytime equates to the chicken laying an egg (however, these intervals are configurable and adjust as the system gets to know the individual bird). Since the RFID tag 80 proximity and orientation can change as the bird moves while nesting and the RFID antenna is powered only intermittently (so as to not disturb the bird while nesting), a caching mechanism may be put in place in an embodiment. This caching mechanism keeps track of the amount of time since a specific tag 80 was read by the RFID reader 70-2 on a specific nesting box (or in a specific location). After the tag 80 was not read for the configurable amount of time (for example, 20 minutes), the tag 80 is removed from the cache and is no longer reported as being present. When the data is reported it contains the tag, the nesting box and the cache time to allow further business decisions to be made about what threshold (in cache age) determines that a chicken left the nest.

By virtue of collecting the information about what bird is on a specific nesting box (or other places) at a specific time, embodiments may also detect desirable or undesirable behaviors in specific animals. An example of this type of detection is when a bird that regularly nests on a single nesting box starts nesting on multiple nesting boxes in the same day. When this happens, it can mean that the bird has a plugged vent or other problem preventing an egg from being laid. One embodiment of this behavior detection is identifying birds who are eating eggs. Embodiments detects this behavior by identifying that a first chicken was present in the nest long enough to lay an egg and then a second chicken went onto the same nest right afterwards for a short period of time.

Smart-Sensors 104, as illustrated in FIG. 2, may be a combination of sensors 102 and computing/software designed to gather specific types of data. For example, a light level sensor simply gathers light data at a set interval. A smart-sensor 104 with a light sensor has the ability to detect low light levels and trigger an event to indicate the condition detected. Another smart sensor 104 might include both a light sensor and an actual light which would be turned on and off based on input from the sensors and/or system. The event(s) gathered from sensors 102 may result in action being taken either within or externally to the system 100. An example of an internal action might be to automatically turn on a light or to open a shade etc. An example of an external event may be to notify a user (via the system) that the light levels have reached undesirable thresholds so that they can decide what/if an action should take place. This system is comprised of a variety of sensors 102 and smart-sensors 104 that work in concert to monitor multiple aspects of environmental and/or behavioral data. This data may be collected and published to the internet via a Communications Gateway 106 which is responsible for collecting the data from each smart-sensor 104 or sensor 102 and sending it to the web where it is stored and available for visualization, further processing, alerting etc.

The smart-sensors 104 in an embodiment are pluggable which means that many may be connected together either directly to a communications gateway 106 or “chained” together and eventually connected to a Communications Gateway 106. For example, a single communications gateway 106 may connect to one or more smart-sensors 104. Each smart-sensor 104 in turn may be connected to additional smart-sensors 104 which may be connected to even more smart-sensors. In this way the sensors 102 may be chained together to create a mesh-network of devices, each specialized in its own (optionally unique) data collection and optionally configured to respond to events generated either within the system or external to the system.

The communications gateway 106 in an embodiment is responsible for collecting and distributing data to and from both smart-sensors 104 and the internet 112. The communications gateway 106 may also be responsible for collecting data from some sensors 102-6. The gateway 106 may connect to the internet 112 through a variety of methods depending on its environment. Different communications approach options may include WiFi, Cellular (e.g. LTE, CDMA, etc), Zigbee, Bluetooth, Micro base stations, etc. Data received from smart-sensors 104 may include an identifier for that smart-sensor 104. This identifier can allow bi-directional communications to take place from and to the smart-sensors 104. This communication is facilitated by the communications gateway 106. The data may come from/go to the internet 112 or even from other units in the field. This bidirectional communications strategy allows smart-sensors 104 to evolve to support greater functionality over time—including but not limited to controlling power output to other devices, sending commands to other smart-sensors 104 or even communicating with external systems via an established protocol/method.

Control Systems, such as environmental control 90 of FIG. 1 and control system 108 of FIG. 2 are designed to control external devices/systems. Control Systems 90 and 108 may optionally be connected to sensors 102 and/or smart-sensors 104. An example of one of these systems would be to control a light, a heater, a power outlet, opening/closing of a door, turning on/off a fan, etc.

An array of sensors 102 are part of the smart design of a connected coop in an embodiment. Each cluster of one or more sensors 102 may be connected to a hub (such as gateway 106 in an embodiment) which may be responsible for polling the sensor data and forwarding it to a central location where it may be published to the internet 112. A smart-sensor 104 may also be able to receive data from the central location & control or adjust items such as power switches, sensor collection granularity/sensitivity, reporting frequency, etc. An RFID smart-sensor can be comprised of one or more RFID readers controlled by a single microcontroller which facilitates gathering data from each RFID reader. The microcontroller may use a toggling approach to turn each reader on and off in order to be able to collect RFID data from a larger area than a single reader can cover. The sum of these parts is one embodiment of a smart-sensor 104. More than one smart RFID sensor can be used together to monitor an even larger space or multiple places such as individual nesting boxes for a chicken coop. In this way the mix-and-match approach of this project creates an adjustable product that can be simply built to be appropriate for a variety of environments. In other examples, Near Field Communication (NFC) and NFC devices might be used for different sensor devices to minimize RF transmission levels in coop. In still another example, Bluetooth devices might be used.

In one embodiment, a single RFID reader 70-2 is used to monitor many locations by implementing a control system with a microcontroller which toggles different antennas on and off. This implementation allows detection of RFID tags 80 across a greater surface area and in multiple discrete locations (for example a nesting box or around a feeding/watering area). By toggling each antenna on and off we are able to significantly extend the capabilities of a single RFID reader 70-2. Combining the tags 80 that were read by the RFID reader with the data in the microcontroller about which antenna was on at the time gives us the unique number of the antenna that was turned on when the tag was read. This information is used to combine the number of the tag 80 that was read with the specific antenna that it was read on which combine to give the location of the bird at the time of reading.

As data is gathered/stored and behavior is observed/captured the system 50 and 100 has the option of requesting additional factual or meta-information about the animal(s). Examples of facts about animals may include, birth date, number of offspring born/raised, breed and sex that can be stored the database 64 or 120. Combining factual information about each animal with the data gathered by the sensor-network provides the opportunity to develop deep intelligence about individual animals and the flock as a whole as well. This information can further be aggregated to further understand behavior across flocks, regions, breeds, age, social status etc.

By trending the data averages within the system it will be possible to see how animals behaved compared to their peers in other locations/flocks or themselves from another period of time and/or under different circumstances. Trending this data allows for comparisons that over time that can showcase abnormalities which may deserve additional attention in order to secure the animal's welfare or increase production.

Given the capabilities of the system in relation to deriving key events and controlling environmental circumstances embodiments allows for a unique level of experimentation across sets of animals. One example of an experiment that could be performed is to change the temperature in a chicken coop by 5% up or down and compare the results in egg production across breeds of birds. These type of experiments would enable a quantitative approach to identify animal husbandry best practices.

In embodiments, key events trigger notifications for animal behaviors. For example, when an egg is laid by a chicken, the owner may receive a notification which enables them to retrieve eggs as quickly as possible which may help prevent egg-eating by other birds and reduce the need to spot check for eggs. In embodiments that monitor the volume level of the hens with audio sensors, when key events happen can be determined. For example, when a hen lays an egg, the hen can make a sort of crowing noise. In an embodiment, a combination of the time a hen is in a nest and a detection of a crowing noise may be used to indicate the hen has laid an egg.

Embodiments that monitor chicken's nesting behaviors may provide insight to the health of the chickens. If a bird nests abnormally it may indicate a health problem. For example, when a chicken is broody, they tend to 6sit on the nest for an extended period of time. Alerting people about the chicken's broody behavior may help the owner quickly take steps to ameliorate the situation and may more quickly provide long-term benefit to the overall flock (such as happiness, production etc.). In another example, if a hen who usually takes 45 minutes to lay an egg (which is tracked with the sensor data), starts nesting for 1.5 hours on two or more nests in one day the chicken should be checked for pasted vent (basically where their egg laying orifice is plugged). Other health conditions can be detected with this system, including but not limited to, early identification of problems such as bird-flu or other issues that impact birds and/or humans.

Event notifications in embodiments also enable management from remote locations or during times of the day when people are not available to check on their animals. An example of this type of notification may include detection of uncommon amounts of noise in the middle of the night. The system can detect this type of abnormal behavior and notify the people responsible for the animals to check the condition of their animals to possibly eliminate critical situations such as predators, fires, burglary etc. When a flock has a predator in the coop—they are very noisy—this volume (level and time) can be used to identify these events within the coop and provide a basis for an alarm.

Based on historical trends across the entire system embodiments may use prediction strategies such as machine-learning to forecast key events for animals and/or their environment. Prediction can help a farmer/owner make decisions about the welfare of all animals under their control and to have context about expected behavior compared to actual behavior for new animals they have never raised before. An example of prediction is upward or downward trend of egg or milk production which can help people make decisions about when to raise more or less animals in order to achieve the desired outcome. The system can take a desired outcome and help the individual manage their animals in order to achieve that objective. Although the system is described herein with particular application to chicken coops, it is to be understood that the system is not limited to such and may be utilized with various types of animals, livestock, and general animal husbandry.

### Example Embodiments

Example 1 is a monitoring and environmental control system for animal housing. The system includes at least one sensor to monitor animal behavior, at least one database to store sensor data from the at least one sensor, at least one environmental control to control at least one environmental system associated with the animal housing, at least one memory to store operating instructions and at least one system controller. The at least one system controller is in communication with the at least one memory. The at least one system controller is also in communication to receive sensor data from the at least one sensor. Moreover, the at least one system controller is further in communication with the at least one database. The at least one system controller is configured to implement the operation instruction to activate the at least one environmental control to adjust the at least one environmental system based at least in part on sensor data from the at least one sensor. The monitoring and environmental control system for animal housing further includes at least one user interface in communication the at least one system controller.

Example 2, includes the system of Example 1, further including at least one environmental sensor to sense environmental conditions associated with the animal housing, the at least one system controller in communication with the at least one environmental sensor.

Example 3 includes the system of Example 2, wherein the system controller is configured to implement instructions to generate an alarm based on select sensor data from at least one of the at least one sensor to monitor animal behavior and the at least one environmental sensor.

Example 4 includes the system of any of the Examples 2-3, wherein at least one of the at least one sensor to monitor animal behavior and the at least one environmental sensor is a smart sensor configured to activate an element control based upon detection of defined sensor data.

Example 5 includes the system of any of the Examples 2-4, wherein the at least one system controller is configured to aggregate activity information across disparate groups of animals to determine at least one of trends, anomalies and factors.

Example 6 includes the system of any of the Examples 2-5, wherein the at least eon system controller is configured to implement prediction instructions stored in the at least one memory based on historical trends of the sensor stored in the at least one database.

Example 7 includes the system of any of the Examples 2-6, wherein the at least one sensor to monitor animal behavior further comprises at least one location sensor; and at least one audio sensor, the at least one system controller configured to generate an indication that a chicken has laid an egg based at least in part on sensor data from at least one of the location sensor and the audio sensor.

Example 8 includes the system of any of the Examples 2-7, further including an identification tag associated with each animal. The at least one sensor further configured to generate sensor data that includes animal identification information based at least in part on gathered identification tag information.

Example 9 includes the system of Example 8, wherein at least one identification tag is a radio frequency identification (RFID) tag and at least one sensor is an RFID reader.

Example 10 includes the system of Example 9, wherein the at least one sensor further includes a plurality of RF antennas and a microcontroller that is configured to toggle different RF antennas on and off in determining locations of animals.

Example 11 is a method of operating an animal monitoring and control system. The method includes monitoring animal behavior with at least one sensor and adjusting at least one environmental system based at least in part on a select monitored animal behavior captured by the at least one sensor.

Example 12 includes the method of Example 11, wherein the monitored behavior is the amount of time the animal stays at a select location.

Example 13 includes the method of Example 12, wherein the select location is a nesting box.

Example 14 includes the method of any of the Examples 11-13, wherein the monitored animal is a chicken and the monitored behavior is a number of nesting boxes used by a chicken in the same day.

Example 15 includes the method of any of the Examples 11-14, wherein monitoring animal behavior with at least one sensor further includes monitoring at least one of audio, lighting, temperature, humidity, location and identification.

Example 16 includes the method of any of the Examples 11-15, wherein adjusting that at least one environmental system is adjusting at least one of a temperature system, a lighting system and a humidity system.

Example 17 includes the method of any of the Examples 11-16, further including tracking the location of each animal with a radio frequency identification (RFID) system.

Example 18 includes a method of operating a chicken monitoring and control system. The method includes: attaching an identifying tag on each chicken to be monitored; tracking the location of each chicken via the attached identifying tag; collecting location data of each chicken over a period of time; and processing the collected location data over a period of time to determine at least one of trends, anomalies and factors.

Example 19 includes the method of Examples 18, further including monitoring the chickens with at least one sensor; collecting sensor data from the at least one sensor; using the collected sensor data along with the collected location data in determining at one of trends, anomalies and factors; and generating at least one of a message and an alarm based on at least one of the determined trends, anomalies and factors indicating an action is needed.

Example 20 includes the method of any of the Examples 18-19, further including monitoring at least one of environmental conditions and chicken behavior with at least one sensor; and adjusting at least one environmental system further based at least in part on one of a monitored environmental condition and chicken behavior.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A monitoring and environmental control system for animal housing, the system comprising:
at least one sensor to monitor animal behavior;
at least one database to store sensor data from the at least one sensor;
at least one environmental control to control at least one environmental system associated with the animal housing;
at least one memory to store operating instructions;
at least one system controller in communication with the at least one memory, the at least one system controller in communication to receive sensor data from the at least one sensor, the at least one system controller further in communication with the at least one database, the at least one system controller configured to implement the operation instruction to activate the at least one environmental control to adjust the at least one environmental system based at least in part on sensor data from the at least one sensor; and
at least one user interface in communication the at least one system controller.

2. The system of claim 1, further comprising:
at least one environmental sensor to sense environmental conditions associated with the animal housing, the at least one system controller in communication with the at least one environmental sensor.

3. The system of claim 2, wherein the system controller is configured to implement instructions to generate an alarm based on select sensor data from at least one of the at least one sensor to monitor animal behavior and the at least one environmental sensor.

4. The system of claim 2, wherein at least one of the at least one sensor to monitor animal behavior and the at least one environmental sensor is a smart sensor configured to activate an element control based upon detection of defined sensor data.

5. The system of claim 1, wherein the at least one system controller is configured to aggregate activity information across disparate groups of animals to determine at least one of trends, anomalies and factors.

6. The system of claim 1, wherein the at least one system controller is configured to implement prediction instructions stored in the at least one memory based on historical trends of the sensor stored in the at least one database.

7. The system of claim 1, wherein the at least one sensor to monitor animal behavior further comprises:
at least one location sensor; and
at least one audio sensor, the at least one system controller configured to generate an indication that a chicken has laid an egg based at least in part on sensor data from at least one of the location sensor and the audio sensor.

8. The system of claim 1, further comprising:
an identification tag associated with each animal; and
the at least one sensor further configured to generate sensor data that includes animal identification information based at least in part on gathered identification tag information.

9. The system of claim 8, wherein at least one identification tag is a radio frequency identification (RFID) tag and at least one sensor is an RFID reader.

10. The system of claim 9, wherein the at least one sensor further comprises:
a plurality of RF antennas; and
a microcontroller configured to toggle different RF antennas on and off in determining locations of animals.

11. A method of operating an animal monitoring and control system, the method comprising:
monitoring animal behavior with at least one sensor; and
adjusting at least one environmental system based at least in part on a select monitored animal behavior captured by the at least one sensor.

12. The method of claim 11, wherein the monitored behavior is the amount of time the animal stays at a select location.

13. The method of claim 12, wherein the select location is a nesting box.

14. The method of claim 11, wherein the monitored animal is a chicken and the monitored behavior is a number of nesting boxes used by a chicken in the same day.

15. The method of claim 11, wherein monitoring animal behavior with at least one sensor further comprises:
monitoring at least one of audio, lighting, temperature, humidity, location and identification.

16. The method of claim 11, wherein adjusting that at least one environmental system is adjusting at least one of a temperature system, a lighting system, a humidity system, a ventilation system, a fan system and a door system.

17. The method of claim 11, further comprising:
tracking the location of each animal with a radio frequency identification (RFID) system.

18. A method of operating a chicken monitoring and control system, the method comprising:
attaching an identifying tag on each chicken to be monitored;
tracking the location of each chicken via the attached identifying tag;
collecting location data of each chicken over a period of time; and
processing the collected location data over a period of time to determine at least one of trends, anomalies and factors.

19. The method of claim 18, further comprising:
monitoring the chickens with at least one sensor;
collecting sensor data from the at least one sensor;
using the collected sensor data along with the collected location data in determining at least one of trends, anomalies and factors; and
generating at least one of a message and an alarm based on at least one of the determined trends, anomalies and factors indicating an action is needed.

20. The method of claim 18, further comprising:
monitoring at least one of environmental conditions and chicken behavior with at least one sensor; and
adjusting at least one environmental system further based at least in part on one of a monitored environmental condition and chicken behavior.
